(19) United States
(12) Patent Application Publication
(10) Pub. No.: US 2006/0090007 A1
(43) Pub. Date: Apr. 27, 2006

(54) Message delivery apparatus, method thereof, system thereof, and program thereof

(75) Inventor: Toshio Tonouchi, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 10/548,561

(22) PCT Filed: Feb. 27, 2004
(86) PCT No.: PCT/JP04/02333

§ 371 Date: Sep. 8, 2005

(30) Foreign Application Priority Data
Mar. 12, 2003 (JP) 2003-065862

(51) Int. Cl. G06F 15/16

(52) U.S. Cl. 709/245

(57) ABSTRACT

A node (500) transmits a message to a reception node (501) via a message router (600). In the message router (600), a DB (database) read unit (240) extracts, as reception target candidate nodes, nodes in a sub-tree rooting in a domain designated by a domain path that is an attribute value representative of a message receiver. A policy engine (610) applies a policy, which has been imparted to a reception target node, to the header of the message, and selects the reception node. In this way, an appropriate node is selected in accordance with the characteristics of a message, thereby realizing linkage between nodes, such as introduction of front processing service nodes.

### TECHNICAL FIELD

The present invention relates to a message delivery apparatus, a method therefor, a system therefor, and a program therefor and, more particularly, to a message delivery scheme of delivering a message from a given communication node to a plurality of associated communication nodes through a network.

### BACKGROUND ART

According to message-oriented middleware such as Java (R) messaging service (JMS; http://java.sun.com/products/jms/) whose specifications are defined by Sun or iBus (http://www.softwired-inc.com) available from Softwired which is an implementation of such middleware, a keyword called a topic is attached to a message. A message sender transmits a message with a topic to a message router.

For example, FIG. 21 shows an example of a conventional message delivery system. Receiver communication nodes (to be simply referred to as nodes hereinafter) 500 and 501 are connected to a message router 800 through a network 100. A DB (database) 900 is managed by the message router 800.

Referring to FIG. 21, the receiver node 500 registers in advance, in the message router 800, a topic which the receiver wants to receive. A message with a topic is received by a message reception unit 210 and transferred to a splitter 220. The splitter 220 splits the message into a header and a payload, and transmits the former and the latter to a header interpreting unit 230 and combining unit 260, respectively.

The header interpreting unit 230 interprets the header to comprehend that this message is a registration request message, and extracts the topic and the URL (Uniform Resource Locator) of the node 500. The header interpreting unit 230 stores the topic as a keyword and position information such as the URL of the receiver as a table in the database 900 by using a DB (database) write unit 290. Upon succeeding in registration in the DB 900, the header interpreting unit 230 generates a header for a response message and transfers it to the combining unit 260.

The combining unit 260 generates one response message by combining the header received from the header interpreting unit 230 and the payload received from the splitter 220. The combining unit 260 issues the registration success response message to the node 500 by using a message transfer unit 270.

A message reception unit 520 of the node 500 receives this registration success response message and transfers it to a processing unit 510. With this operation, the processing unit 510 confirms a registration success. Note that the node 501 is a sender node.

Upon receiving a message from the node 501 through the message reception unit 210, the message router 800 transfers it to the splitter 220. The splitter 220 splits the message into a header and a payload, and transfers the former and the latter to the header interpreting unit 230 and combining unit 260, respectively. The header interpreting unit 230 interprets the header to comprehend that the message is a routing target message, and extracts a topic as a transmission target. The header interpreting unit 230 searches the database 900 with the topic of the message by using a DB read unit 240, thereby obtaining the position information of nodes obtained as a result of the search, e.g., a set of URLs of the node 500 and the like.

The header interpreting unit 230 generates headers corresponding to the list of pieces of obtained position information, and transfers them to the combining unit 260. The combining unit 260 generates messages by copying the payload received from the splitter 220 to the respective headers received from the header interpreting unit 230, and transfers the messages to the message transfer unit 270. The message transfer unit 270 transmits the messages to receiver nodes such as the node 501. The transmitted message is received by, for example, the message reception unit 520 of the node 500, and transferred to a processing unit 510. The processing unit 510 performs processing corresponding to the received message.

Assume that a message to members belonging to a sales division is topic “Sales Div”. Assume also that a topic to the first section of the sales division is “1st sec”. The message of topic “Sales Div” should also be transmitted to a receiver who wants to receive topic “Sales Div”. Without a hierarchical topic structure as in the case of JMS, a member belonging to the first section of the sales division needs to register the receiver for both topics “Sales Div” and “1st sec”.

In addition, since JMS cannot implement a message addressed to a plurality of receivers, it is difficult for a node which has received a given message to transfer it to another node. Assume that a given service provision node and authentication node exist. In this case, only a message authenticated by the authentication node needs to be supplied to the service provision node. If, however, a message is supplied by using a topic set by the service provision node, the message is supplied to the service provision node regardless of the presence/absence of the authentication node. This allows the use of even the service of unauthenticated messages. As described above, this makes it difficult to add a front processing service of performing authentication processing before a given process as in the case of an authentication server.

According to XLANG defined by “Web Services for Business Process Design”, services are linked to each other by introducing routing information to the header of the simple object-access protocol (SOAP) used for Web services. A service provider provides a service by checking the payload of a SOAP message, and determines the next transfer destination of the message by checking the header. According to XLANG, each transfer destination is specified in a header. For this reason, if there are many service-linking nodes, the header size increases to result in poor efficiency.

In a system constructed by message-oriented middleware or a client-server system, if a service provider exists in the Internet, the provider is accessed by unspecified service users. For this reason, a service rejection attack is known, in which a given malicious service user makes many accesses to the service provider at once to hinder other service users from using the service.

According to the ingress filtering technique, when the provision of services is restricted to specified users, a service rejection attack is prevented by physically and logically filtering packets having sender addresses other than those of the service users before they are delivered to the service provider. If, however, any service users cannot be specified, ingress filtering cannot be used.

According to the invention disclosed in Japanese Patent Laid-Open No. 2001-273209, a limitation is imposed on the number of connection requests for a service provider, and any connection request exceeding the limitation is rejected. In this case, if a malicious service user makes requests exceeding the request count limit, it is difficult for valid service users to use services.

According to the invention disclosed in Japanese Patent Laid-Open No. 2002-158699, a transmission source attaches a mark which guarantees safety to a message, and a service provider provides a service upon attaching a priority to it in accordance with the safety. In this invention, a transmission source must be equipped with a mechanism of attaching a mark which guarantees safety. This technique can be realized when service users make accesses through a specific ISP (Internet Service Provider). In general, however, Internet users do not necessarily make accesses through an ISP having a mechanism of attaching a mark which guarantees safety, and hence this technique is difficult to realize.

A distributed service rejection attack is an attack in which a malicious node attacks a service provider by using other unmalicious nodes instead of directly attacking the provider. Nodes which are used by a malicious node will be referred to as stepping-stone nodes. According to the device disclosed in Japanese Patent Laid-Open No. 2002-158660, an attack blocking function is provided for each stepping-stone node. Upon detecting a distributed service rejection attack, an attack detection function instructs the attack blocking function to reject any access from the stepping-stone node to the service provider. It is, however, difficult to specify stepping-stone nodes in advance, and hence it is not practical to provide the attack blocking function.

The conventional techniques therefore have the following problems. The first problem is that in a system in which many nodes as service providers which provide services and information exist as in the case of the Internet, there is no message-oriented middleware which allows nodes to efficiently coordinate with each other. For example, it is difficult to realize a method of limiting accesses to a service providing node by providing an authentication service providing node without changing the existing service providing node.

This is because conventional message-oriented middleware simultaneously delivers a message to corresponding target receivers. For this reason, it is impossible to realize processing with a sequence in which a service is provided from a service providing node after authentication is succeeded by an authentication server.

The second problem is that it is difficult to transmit a message to a node which is interested in a topic including a topic which the message has. A message having topic “Sales DiV” should be transmitted to a node registered with topic “1st sec” included in “Sales Div” as well as a node registered with “Sales Div” as a topic.

The reason why such operation is difficult to realize is that topics do not have an inclusion relation. For this reason, it cannot be designated that “Sales Div” is a topic including “1st sec”.

The third problem is that in an open network such as the Internet, a service provider may receive a service rejection attack. This is because a node as a service provider may be connected to the Internet. In this case, any nodes can access this node. Therefore, when a malicious node applies an excessive load on a service provider, it is difficult to provide normal services.

The fourth problem is that an open network such as the Internet, a service provider may receive a distributed service rejection attack. This is because a node as a service user can be accessed by any nodes. Therefore, a malicious node applies an excessive load on a service provider by using service users to make it difficult to provide normal services.

### DISCLOSURE OF INVENTION

It is the first object of the present invention to provide a message delivery apparatus which includes message-oriented middleware capable of processing a message delivery sequence, a method therefor, a system therefor, and a program therefor.

It is the second object of the present invention to provide a message delivery apparatus which includes message-oriented middleware capable of designating a delivery destination by using topics having an inclusion relation, a method therefor, a system therefor, and a program therefor.

It is the third object of the present invention to provide a message delivery apparatus which can prevent a service rejection attack against a service provider even in an open network environment such as an Internet environment, a method therefor, a system therefor, and a program therefor.

It is the fourth object of the present invention to provide a message delivery apparatus which can prevent a distributed service rejection attack against a service provider even in an open network environment such as an Internet environment, a method therefor, a system therefor, and a program therefor.

In order to achieve the above objects, according to the present invention, there is provided a message delivery apparatus which delivers a message to a node connected to a network, characterized by comprising a database in which pieces of node information of message delivery destinations are stored as a tree data structure conforming to a predetermined relationship, retrieval means for retrieving all node information included in sub-trees having, as a root, reception node information of the message which is added to a header portion of the message by accessing the tree data structure of the database on the basis of the reception node information, and transfer means for transferring the message to delivery destinations corresponding to all the retrieved node information. In this case, a pair of the node information and policy information defining a policy for determining the message delivery destination is stored in the database as the tree data structure, the retrieval means retrieves a pair of the node information and the policy information, and the transfer means transfers the message in accordance with the retrieved information.

In addition, according to the present invention, there is provided a message delivery method of delivering a message to a node connected to a network, characterized by comprising the step of retrieving all node information included in sub-trees having, as a root, reception node information of the message which is added to a header portion of the message by accessing a database in which pieces of node information of message delivery destinations are stored as a tree data structure conforming to a predetermined relationship, on the basis of the reception node information, and the step of transferring the message to delivery destinations corresponding to all the retrieved node information.

Furthermore, according to the present invention, there is provided a message delivery system characterized by comprising a plurality of nodes which are connected to a network and transmit and receive messages, and a message delivery apparatus which is connected to the network and delivers a message transmitted from a node to another node, the message delivery apparatus comprising a database in which pieces of node information of message delivery destinations are stored as a tree data structure conforming to a predetermined relationship, retrieval means for retrieving all node information included in sub-trees having, as a root, reception node information of the message which is added to a header portion of the message by accessing the tree data structure of the database on the basis of the reception node information, and transfer means for transferring the message to delivery destinations corresponding to all the retrieved node information. In this case, firewalls may be provided between these nodes, the message delivery apparatus, each node management apparatus, and the network.

Moreover, according to the present invention, there is provided a program for causing a computer to implement a message delivery method of delivering a message to a node connected to a network, the program causing the computer to implement the step of retrieving all node information included in sub-trees having, as a root, reception node information of the message which is added to a header portion of the message by accessing a database in which pieces of node information of message delivery destinations are stored as a tree data structure conforming to a predetermined relationship, on the basis of the reception node information, and the step of transferring the message to delivery destinations corresponding to all the retrieved node information.

### BRIEF DESCRIPTION OF DRAWINGS

FIG. 1 is a block diagram showing the arrangement of the first embodiment of the present invention;

FIG. 2 is a flowchart showing the operation of the first embodiment of the present invention;

FIG. 3 is a flowchart showing operation associated with a transmission message according to the first embodiment of the present invention;

FIG. 4 is a view showing an example of a transmission message according to the first embodiment of the present invention;

FIG. 5 is a view showing an example of an error message according to the first embodiment of the present invention;

FIG. 6 is a view showing an example of a node leave request message according to the first embodiment of the present invention;

FIG. 7 is a flowchart showing operation associated with a node leave request message according to the first embodiment of the present invention;

FIG. 8 is a flowchart showing operation associated with en error message according to the first embodiment of the present invention;

FIG. 9 is a flowchart showing operation associated with a node registration request message according to the first embodiment of the present invention;

FIG. 10 is a view showing an example of a node registration request message according to the first embodiment of the present invention;

FIG. 11 is a block diagram showing the arrangement of the second embodiment of the present invention;

FIG. 12 is a block diagram showing the arrangement of a policy engine according to the second embodiment of the present invention;

FIG. 13 is a flowchart showing the operation of a policy engine according to the second embodiment of the present invention;

FIG. 14 is a flowchart showing operation associated with a node registration request message according to the second embodiment of the present invention;

FIG. 15 is a view showing an example of a node registration request message according to the second embodiment of the present invention;

FIG. 16 is a flowchart showing operation associated with a transmission message according to the second embodiment of the present invention;

FIG. 17 is a block diagram showing a specific example of the second embodiment of the present invention;

FIG. 18 is a block diagram showing a specific example of the third embodiment of the present invention;

FIG. 19 is a part of a flowchart showing operation associated with a node registration request message according to the third embodiment of the present invention;

FIG. 20 is a part of a flowchart showing operation associated with a node registration request message according to the third embodiment of the present invention; and

FIG. 21 is a block diagram for explaining a prior art.

### BEST MODE FOR CARRYING OUT THE INVENTION

Embodiments of the present invention will be described in detail with reference to the accompanying drawings.

### First Embodiment

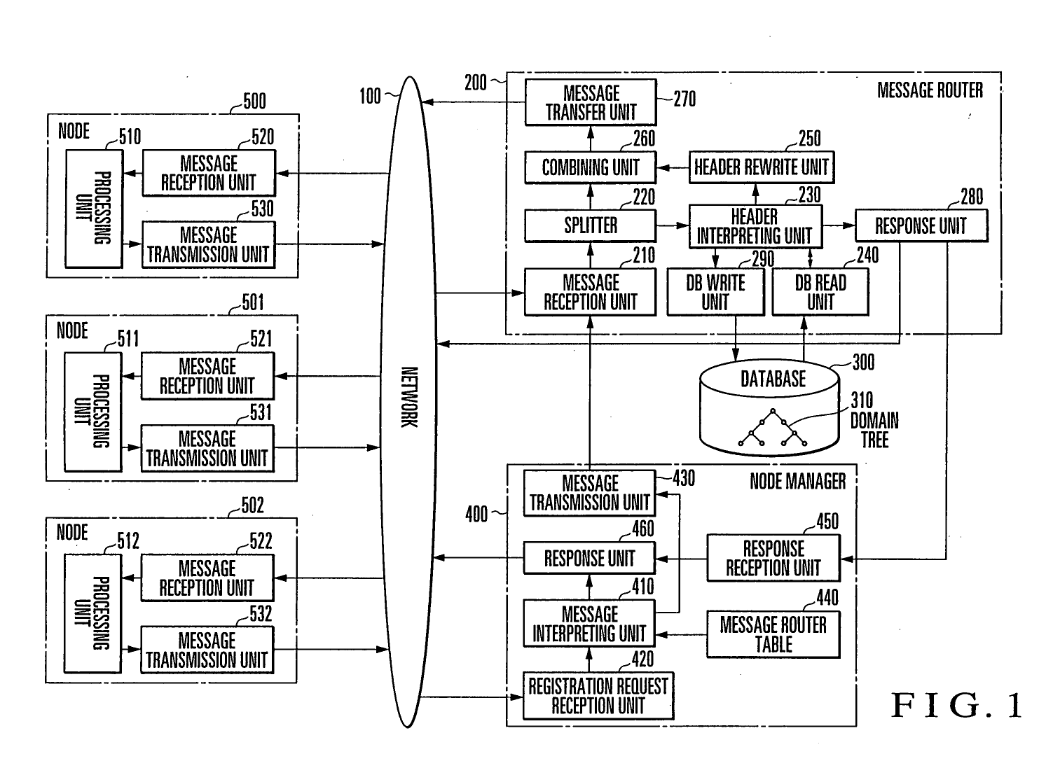

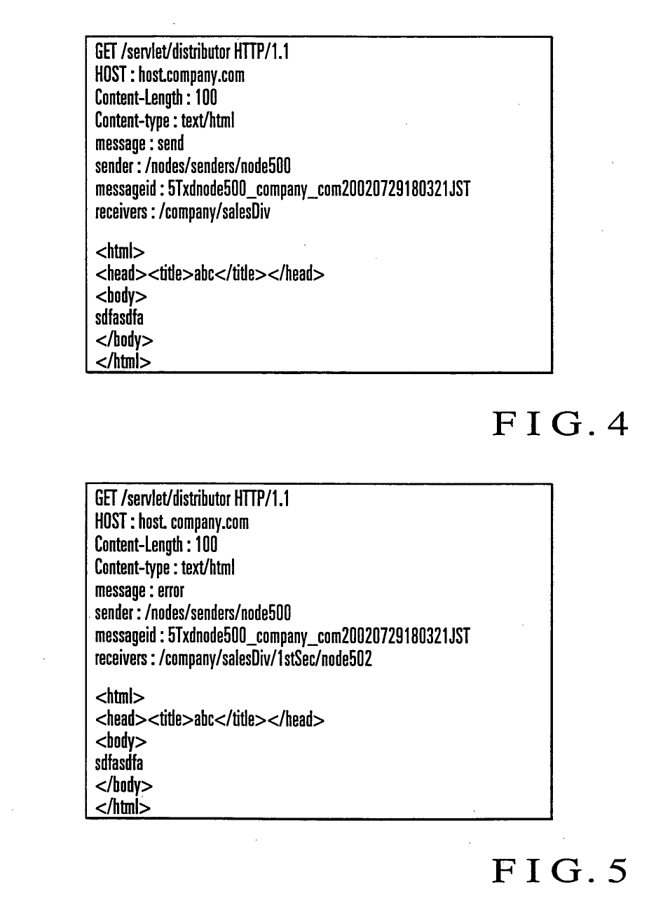

FIG. 1 is a block diagram showing the first embodiment of the present invention. Referring to FIG. 1, a message router (message delivery apparatus) 200, a node manager (node management apparatus) 400, a plurality of nodes 500 to 502 for transmitting and receiving messages, and the like are connected to each other through a network 100. Assume that the nodes transmit/receive messages to/from each other through the message router 200. In the nodes 500 to 502 and the like, processing units 510 to 512 generate messages like those described in detail later with reference to FIG. 4, and message transmission units 530 to 532 transmit the messages to other nodes. Note that messages from other nodes are received by message reception units 520 to 522.

Such a message is an application protocol such as an HTTP (HyperText Transfer Protocol) message or SIP (Session Initial Protocol), and is divided into a header portion and a payload portion. The header portion has a header unique to this embodiment (e.g., message:send) in addition to a header defined in HTTP.

A message reception unit 210 of the message router 200 connected to the network 100 receives a message. The message reception unit 210 transfers the received message to a splitter 220. The splitter (splitting means) 220 splits the message into a header portion and a payload portion, and transfers the message portion and payload portion to a header interpreting unit 230 and the combining unit 260, respectively. The header interpreting unit (interpreting means) 230 extracts appropriate node information from a domain tree 310 stored in a database 300 through a DB read unit (retrieval means) 240 by using the value of an attribute (e.g., a receivers attribute)., of the header portion of the message, which indicates 0 or more receiver groups.

In this case, node information is position information such as the URL (Uniform Rsource Locator) of the node 500 or the like. A domain tree is a tree structure having node information or a set of pieces of node information called a domain as a node. Each node is assigned a name. Node information or a domain can be uniquely designated by placing the names of the nodes in a row from the root of the tree by using “/” as a delimiter. This name is called a domain path. The value of a receivers attribute is a domain path. The above “appropriate node information” is the node information designated by the domain path as a receivers attribute value or all pieces of node information included in sub-trees having, as a vertex, the domain designated by the domain path.

The header interpreting unit 230 transfers the set of pieces of node information and the header portion to a header rewrite 250. The header rewrite (rewrite means) 250 removes receivers attribute and its value from the message, adds an attribute (e.g., routerUrl attribute) indicating the position information of the message router and the URL of the message router as its value to the message, and sends the resultant message to a combining unit 260. The combining unit (combining means) 260 generates a new message by adding the payload received from the splitter 220 to the end of the header from the header rewrite unit 250. The combining unit 260 sends the message and the position information such as a URL representing a node, which is received from the header rewrite 250, to a message transfer unit 270. The message transfer unit (transfer means) 270 transmits the message to the node designated by the position information such as a URL received from the combining unit 260. The message transmitted from the message transfer unit 270 arrives at the message reception unit 521 of the node 501 and transferred to the processing unit 511 to be processed.

Pieces of node information associated with nodes such as the node 500 must be registered in the database 300 in advance. The node manager 400 accepts a registration request from a node. That is, a registration request reception unit 420 receives the registration request message from the node and transfers it to a message interpreting unit 410. The message interpreting unit 410 obtains position information such as the URL of the message router registered in a message router table 440. The message interpreting unit 410 transmits the message to the message router 200 through a message transmission unit (transfer means) 430.

A response reception unit 450 receives a result of the registration request output to the message router 200. A response unit 460 receives a message indicating the response result from the response reception unit 450, and transmits it as a response message to the person who has issued the registration request.

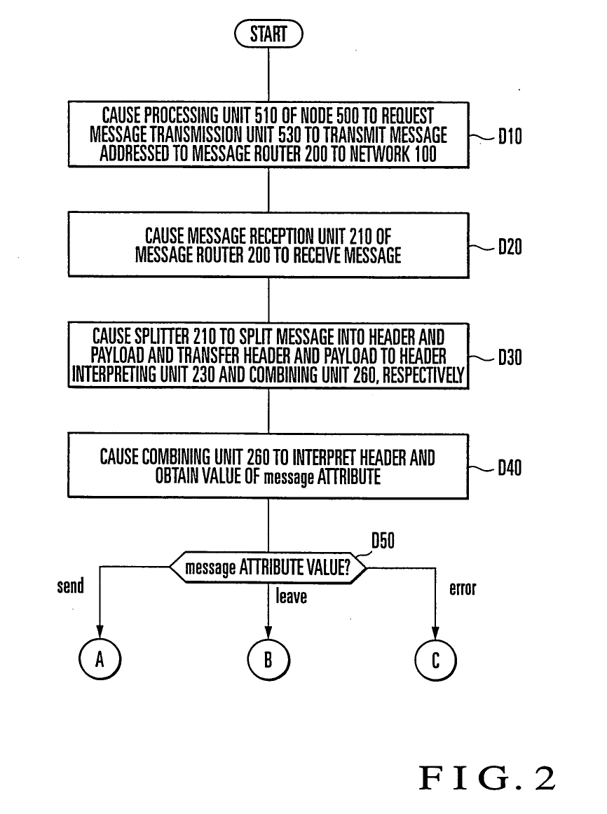

FIG. 2 is a flowchart showing message transmission of the operation of the first embodiment of the present invention. First of all, the processing unit 510 of the node 500 requests the message transmission unit 530 to send the message addressed to the message router 200 to the network 100 (step D10).

The message reception unit 210 of the message router 200 receives the message (step D20). The splitter 220 splits the message into a header and a payload, and transfers the header and payload to the header interpreting unit 230 and combining unit 260, respectively (step D30).

The header interpreting unit 230 interprets the header and obtains the value of an attribute (e.g., message attribute) representing the type of message (step D40). The value of message attribute is a message transmission message (e.g., “send” as the value of message attribute), a leave request message from the node (e.g., “leave”), or an error message (e.g., “error”). The flow of processing branches depending on the value (step D50).

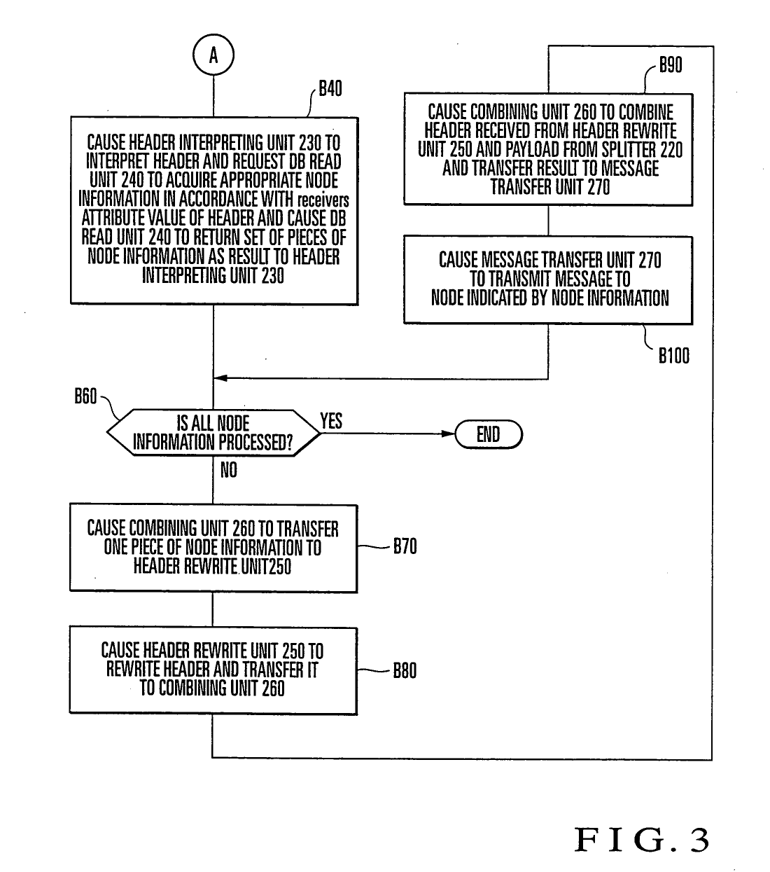

FIG. 3 shows processing, of the operation of the first embodiment of the present invention, which is to be performed when the value of message attribute indicates a message transmission message, i.e., “send”. The header interpreting unit 230 interprets the header, and requests the DB read unit 240 to acquire appropriate node information in accordance with the value of the attribute (e.g., receivers attribute) representing the receiver of the header. The DB read unit 240 returns a set of pieces of node information as a result of this operation to the header interpreting unit 230 (step B40). The next processing is repeated until the set becomes empty (step B60).

The header interpreting unit 230 transfers one of the elements of the set of header information to the header rewrite 250 (step B70). The header rewrite 250 rewrites the header. That is, the header rewrite 250 deletes receivers attribute from the header and adds an attribute (e.g., routerUrl attribute) indicating position information such as the URL of the currently used message router 200. The value of routerUrl attribute is position information such as the URL of the currently used message router 200. The rewritten header is transferred to the combining unit 260 (step B80).

The combining unit 260 combines the header received from the header rewrite 250 and the payload from the splitter 220 and transfers the result to the message transfer unit 270 (step B90). The message transfer unit 270 transmits the message to the node indicated by the node information (step B100). The node information of the current receiver is deleted from the set of pieces of node information, and the flow returns to step B60 to repeat the processing in steps B70 to B100 until the set of pieces of node information becomes empty. When the set of pieces of node information becomes empty, the processing is terminated.

FIG. 7 shows processing, of the operation of the first embodiment of the present invention, which is to be performed following the flowchart of FIG. 2 when the value of message attribute is a value indicating a leave request from a node, i.e., “leave”. The header interpreting unit 230 interprets the header, and requests a DB write unit 290 to delete the node designated by the value of an attribute (e.g., sender attribute) indicating the transmission node of the header (step E40). The DB write unit 290 deletes the designated node information from the database 300 (step E50).

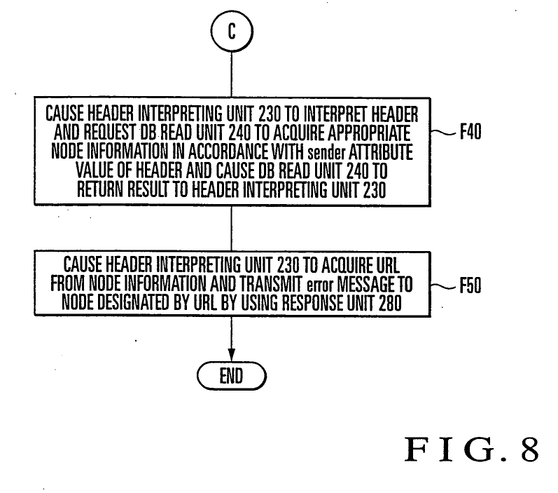

FIG. 8 shows processing, of the operation of the first embodiment of the present invention, which is to be performed following the flowchart of FIG. 2 when the value of message attribute is a value indicating an error message, i.e., “error”. When an error occurs in processing associated with a reception message whose message attribute value is “send”, a node as the receiver of the message or a message router generates an error message. If, for example, an error occurs in the node 500, the processing unit 510 generates an error message.

Message attribute is “error”. The value of sender attribute is a domain path indicating the sender of the original message in which the error has occurred. The value of an attribute (e.g., messageid attribute) which has a message identifier as a value is the same value as that of messageid attribute of the original message. Receivers attribute is the domain path of a node in which the error has been found (i.e., the receiver node 500). The generated error message is transmitted to position information such as the URL of a message router which is the value of routerUrl attribute of the original message.

The header interpreting unit 230 interprets the header, and requests the DB read unit 240 to acquire appropriate node information in accordance with the value of an attribute (e.g., sender attribute) indicating the transmission node of the header. The DB read unit 240 returns the result to the DB read unit 240 (step F40). The header interpreting unit 230 causes a response unit 280 to acquire position information such as a URL from the node information, and transmits the error message to the node designated by the position information such as a URL (step F50).

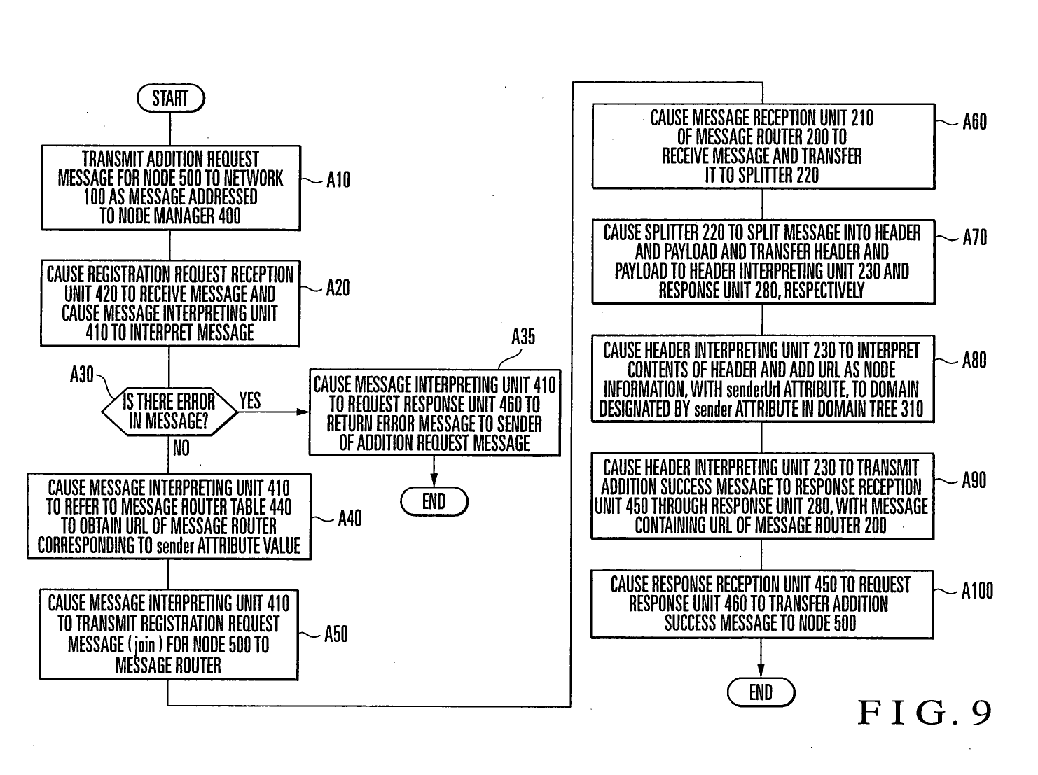

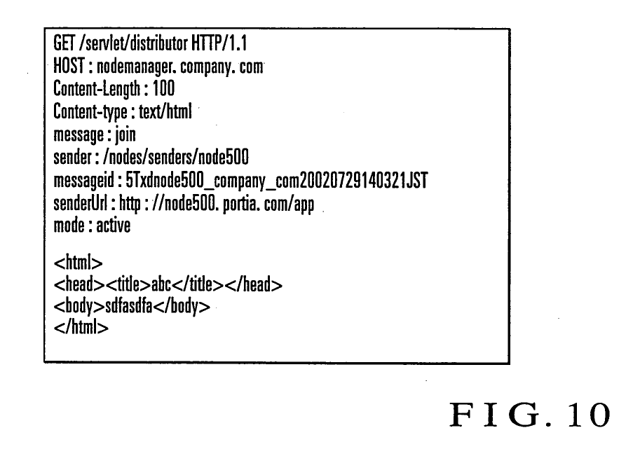

FIG. 9 shows operation, of the operation of the first embodiment of the present invention, which is to be performed to register node information in the database 300. An addition request message from the node 500 is sent as a message like that shown in FIG. 10 to the node manager 400 through the network 100 (step A10). The registration request reception unit 420 of the node manager 400 receives the message and sends it to the message interpreting unit 410.

The message interpreting unit 410 interprets the message (step A20). In the process of interpretation, the message interpreting unit 410 determines whether there is an error in the message (step A30). If an error is found in the message, the message interpreting unit 410 requests the response unit 460 to return an error message to the person who has issued the addition request, i.e., the node 500 (step A35).

If there is no error, the message interpreting unit 410 looks up the message router table 440 to obtain position information such as the URL of the message router corresponding to a sender attribute value (step A40). In the first embodiment, since it is assumed that one message router is registered in the message router table 440, the same position information such as a URL is always returned. The message interpreting unit 410 transfers a registration request message from the node 500 to the message router (step A50). The message reception unit 210 of the message router 200 receives the message, and transfers it to the splitter 220 (step A60).

The splitter 220 splits the message into a header and a payload, and transfers the header and payload to the header interpreting unit 230 and combining unit 260, respectively (step A70). The header interpreting unit 230 interprets the contents of the header, and uses the DB write unit (registration means) 290 to add position information such as a URL as node information to the domain designated by sender attribute in the domain tree 310 with an attribute (e.g., sender URL attribute) indicating the position information of the transmission node (step A80). The header interpreting unit 230 transmits an addition success message including position information such as the URL of the message router 200 to the response reception unit 450 through the response unit 280 (step A90).

The response reception unit 450 requests the response unit 460 to transfer the addition success message to the node 500 (step A100). This message includes position information such as the URL of the message router 200. Subsequently, the node 500 transmits a message whose attribute value is “send” to the message router indicated by position information such as this URL.

The operation of this embodiment will be described next by using a specific embodiment. Assume first that the URL of the message router 200 is “http://distributor.compnay.com/servlet/distributor”, and the URL of the node manager 400 is “http://nodemanager.compnay.com/servlet/distributor”. Assume also that the URL of the node 500 is “http://node500.portia.com/app”.

Assume first that the node 500 is registered as domain path /nodes/senders/node500 in the message router 200. In this case, the person who requests node registration issues a message like that shown in FIG. 10 to the node manager 400. Referring to FIG. 10 (ditto for FIGS. 4 to 6), the first to fourth lines indicate an HTTP header, and the fifth to ninth lines indicate attributes defined in this embodiment. The 10th line (blank line) indicates a separator for the header and payload. The 11th and subsequent lines indicate the payload. Note that in this embodiment, an HTTP header and attribute will be referred to as a header.

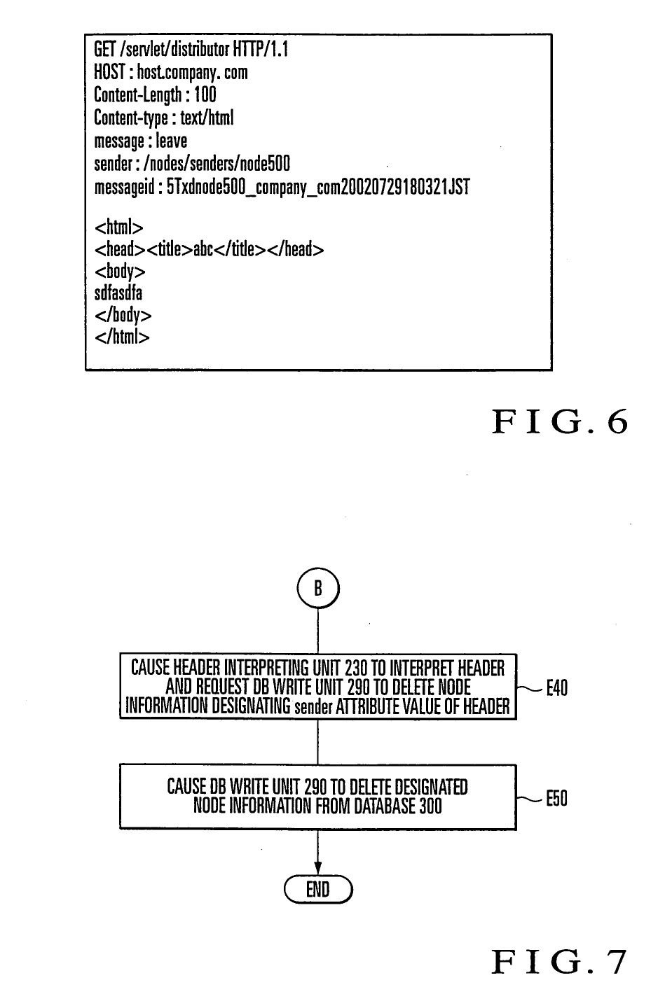

Message attribute represents the type of message, and “join”, “leave”, “send”, or “error” is defined as the value of the attribute. “Join” corresponds to a registration request message from a node (FIG. 10); “leave”, a work (leave) request message for removing a registered node from the registration (FIG. 6); “send”, a data communication message (FIG. 4); and “error”, an error notification message when an error has occurred in a “send” message (FIG. 5).

A person who requests node registration issues a registration request message to the node manager 400. The leave target node 500 issues a “leave” message to the message router 200. A registered node issues a “send” message and “leave” message to the message router 200.

In a registration request message, sender attribute designates a registration destination for a registration target node. Messageid is an identifier which is attached to a message by a person who requests registration on his/her responsibility to globally and uniquely guarantee the message. SenderUrL attribute is a URL designating the message reception unit 520 of the node 500. A message to the node 500, i.e., /nodes/senders/node500, is transmitted to this URL. An attribute (e.g., mode attribute) representing a transmission mode designates a message transmission mode for the node 500.

In the case of a mode attribute value (e.g., “active”) set when a receiver node has opened a server socket, the message reception unit 520 of the node 500 has opened a server packet as a server and waits for a message. In the case of a mode attribute value (e.g., “passive”) set when a receiver node cannot open a server socket, the message reception unit 520 periodically polls the message router 200 to check whether any message addressed to the node 500 has arrived. When the node 500 is in a firewall or cannot open a server socket because it has no global IP address, “passive” is used.

This registration request message is received by the registration request reception unit 420 and sent to the message interpreting unit 410. URL “http://distributor.company.com/servlet/distributor” of the message router is obtained from the message router table 440. Assume that in this embodiment, the router 200 is only the message router registered in the message router table 440. The message transmission unit 430 transmits the registration request message to URL “http://distributor.company.com/servlet/distributor”, i.e., the message router 200. The message reception unit 210 of the message router 200 accepts this message. The splitter 220 extracts the first to ninth lines in FIG. 10 which is the header portion of the message and transfers it to the header interpreting unit 230.

The header interpreting unit 230 uses the DB write unit 290 to register node information “http://node500.portia.com/app” of the node 500 as domain/nodes/senders element of the domain tree in the database 300. The header interpreting unit 230 uses the response unit 280 to return a success response to the response reception unit 450. The response reception unit 450 returns a response to the registration request message sender through the response unit 460.

A specific embodiment in which the node 500 transmits a message to the nodes 501 and 502 will be described next. Assume that the node 501 is registered in domain/company/salesDiv/node501, and its URL is “http://node501.portia.com/app”. Assume also that the node 502 is registered in domain/company/salesDiv/1stSec/node502, and its URL is “http://node502.portia.com/app”.

The processing unit 510 of the node 500 transmits the message shown in FIG. 4. The value of receivers attribute is a domain path representing a set of receivers (message delivery destinations). Since the receivers attribute value is /company/salesDiv, the nodes 501 and 502 included in sub-trees having domain/company/salesDiv as a root are transmission targets. This message is transmitted to the message transmission unit 530 and received by the message reception unit 210.

The splitter 220 transfers the header (the first to eighth lines) of the message shown in FIG. 4 to the header interpreting unit 230. The header interpreting unit 230 extracts receivers attribute value “/nodes/receivers” and requests the DB read unit 240 to return all the nodes of sub-trees having domain/nodes/receivers as a root. The header interpreting unit 230 obtains “http://node501.portia.com/app” and “http://node502.portia.com/app” as node information. The header rewrite 250 adds attribute value “http://distributor.company.com/servlet/distributor” as routerUrl attribute to the respective URLs, and converts the headers into headers with receivers attributes “/company/salesDiv/node501” and “/company/salesDiv/1stSec/node502”.

The header rewrite 250 transfers the converted headers to the combining unit 260. The combining unit 260 attaches payloads (the 10th and subsequent lines in FIG. 4) to the headers, and requests the message transfer unit 270 to transmit the respective messages to the nodes 501 and 502.

As is obvious from the above description, if concerning a company organization, the domain tree 310 of the database 300 is, for example, configured such that branches diverge and spread to/from organizations in order of decreasing scale like a division, section, subsection, group, and the like, and is also formed as a tree structure such that the respective organizations are associated with each other. As in the above case, when the sales division (salesDiv) of the company organization (company) is designated by a receivers attribute value which is a domain path representing a set of receivers (message delivery destinations), all the nodes (receivers) included in sub-trees having the sales division (salesDiv) of the company organization (company) as a root become transmission targets.

The following is a case wherein an error has occurs in this message in the node 502. Assume that the processing unit 512 of the node 502 has failed in reception in the message reception unit 522. At this time, the processing unit 512 generates the message shown in FIG. 5. In this case, message attribute is “error”, sender attribute is domain path/node/senders/node500 of the node 500 which is the original message sender, the value of receivers attribute is domain path/company/salesDiv/1stSec/node502 of the node 502, and the value of messageid attribute is messageid identical to that of the original message.

The processing unit 512 transmits a message to the message router 200 indicated by routerUrl attribute of the original message by using the message transmission unit 532. The message received by the message reception unit 210 passes through the splitter 220, and the header interpreting unit 230 obtains node information URL “http://node500portia.com/app” of the node 500 designated by the domain path of sender attribute. This header and URL are sent to the combining unit 260 through the header rewrite 250 to be combined with a payload. The result is transmitted to the node 500 through the message transfer unit 270.

A specific example of how the node 500 transmits a leave message will be described next. The processing unit 510 of the node 500 generates the leave message shown in FIG. 6. Sender attribute of this message is domain path/node/senders/node500 of the node 500. The message transmission unit 530 is used to transmit a message to the message router 200. In the message router 200, the splitter 220 extracts a header from the message received by the message reception unit 210, and transfers it to the header interpreting unit 230. The header interpreting unit 230 extracts sender attribute value “/node/senders/node500”, and deletes node information “/node/senders/node500” by using the DB write unit 290. In this case, the leave message is directly transmitted from the node 500 to the message router 200. However, this message may be transmitted from the node 500 to the message router 200 through the node manager 400.

In this embodiment, pieces of node information are stored in the form of a tree data structure in the database. All the nodes included in sub-trees can be designated by a domain path designating the nodes of trees. This makes it possible to designate nodes with the inclusion relation between designated topics being reflected.

### Second Embodiment

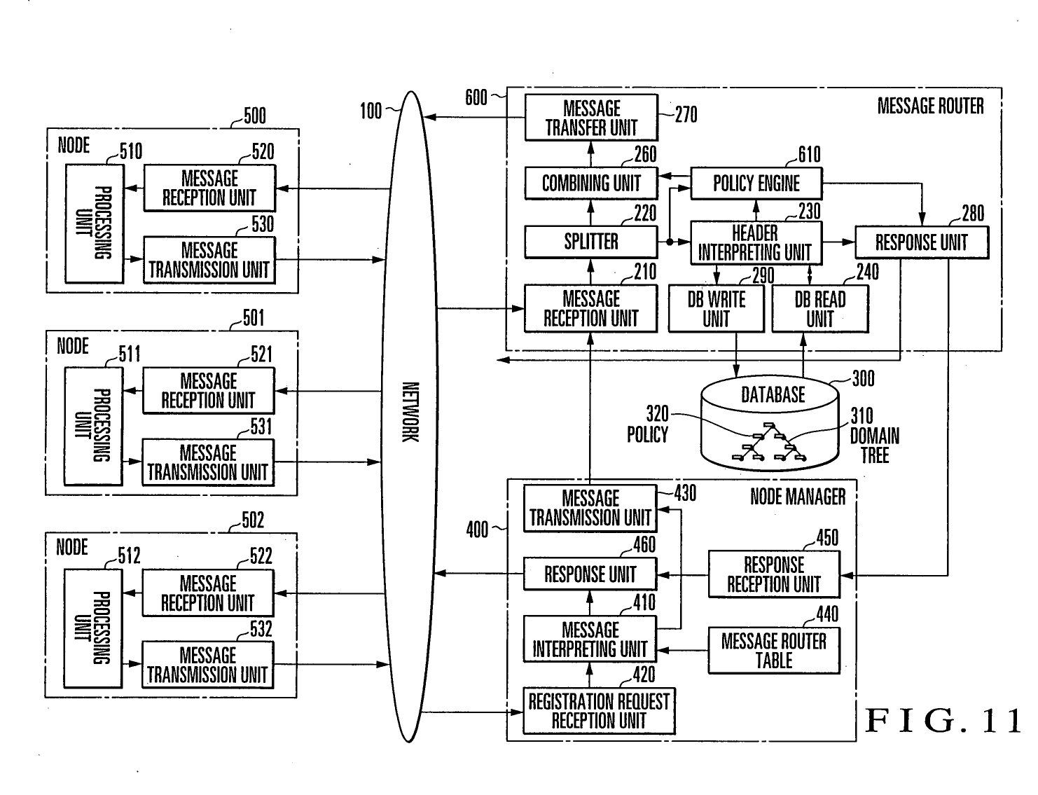

The second embodiment of the present invention will be described next. FIG. 11 is a block diagram showing the second embodiment of the present invention. A message router 600 is equipped with a policy engine 610 in place of a header rewrite unit 250 of a message router 200. The policy engine (collation means) 610 receives a set of pairs of pieces of position information (e.g., URLs) of nodes as transmission target candidates and policies attached thereto and headers, and outputs pairs of the pieces of position information of transmission targets and headers. The policy engine 610 checks whether the policy of a transmission target candidate matches a header. If they match each other, the policy engine 610 generates a new header, and checks whether it matches another policy.

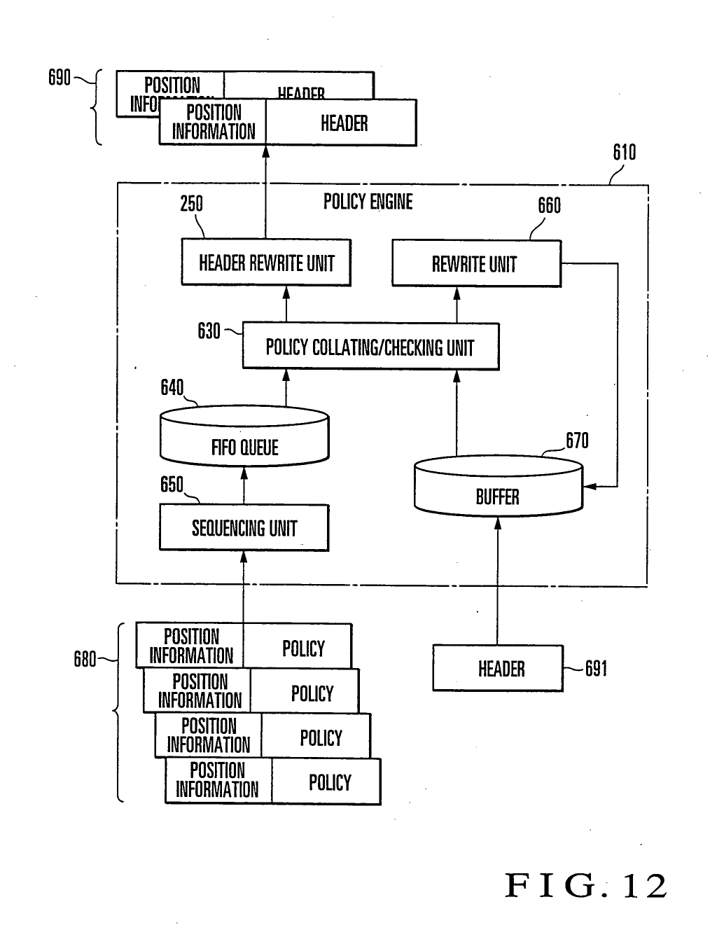

FIG. 12 shows the structure of the policy engine. Assume that there are a plurality of pairs of the pieces of position information (e.g., URLs) of nodes, which are pieces of node information, and policies to be set when the nodes are registered (680). A sequencing unit 650 extracts a set of pieces of node information according to a predetermined rule, and sequentially places them in a FIFO queue 640. In this case, the predetermined rule may be, for example, a scheme of randomly extracting information with random numbers. However, the present invention is not limited to this. The FIFO queue 640 is a queue for storing node information, from which pieces of node information can be extracted in the order in which they are input to the queue.

A buffer 670 can store one header 691 of a message transmission message at most. If, therefore, a header is extracted from the buffer 670, the number of headers stored becomes 0. A policy is a description comprising a collation portion and rewrite portion. The collation portion describes the pattern of the header of a message, and can discriminate whether the header can be collated by the collation portion. The rewrite portion rewrites the contents of the header in consideration of the collation state of the collation portion.

For example, the following policy is conceivable. The collation portion describes a header attribute value in a regular expression, and checks whether the attribute value of the header is collated with the normal expression to discriminate whether collation can be done. The rewrite portion rewrites the collated attribute value with a designated specific character string.

More specifically, a policy means a policy determining a message which should be received by a node. In other words, a policy indicates the characteristics of a message which should be received by a node. Assume that a node 501 is registered in advance by a “join” message with policy “sender=/nodes/senders/|*”. In this case, the node 501 has sender attribute, and receives a message whose value starts with “/nodes/senders/”, e.g., the transmission message shown in FIG. 4. The policy is used to determine a message delivery destination.

Furthermore, in addition to the collation portion, the policy has a rewrite portion to describe message patterns to be received by a plurality of nodes. When a node is ready for reception, i.e., is collated (matched) with the policy of the node, this rewrite portion is used to describe that another node coincides with a reception condition.

A policy collating/checking unit 630 sequentially receives node information and a header, and determines whether the collation portion of the policy of the node information can be collated with the node. If the collation portion cannot be collated, the operation is stopped. If the collation portion can be collated, the policy collating/checking unit 630 outputs the node information, i.e., the pair of the position information and the header and the pair of the collation information and the header. The header rewrite unit 250 is identical to the rewrite unit 250 in FIG. 1, and receives a pair of a header and position information. The value of an attribute (e.g., receivers attribute) indicating the receiver of the header is set as a domain path in which node information is stored, and the position information of the message router 600 is set as the value of an attribute (e.g., routerUrl attribute) indicating the position information of the message router. This position information and header are output as a pair 690.

A rewrite unit 660 receives the information of the collating operation performed by the policy collating/checking unit 630, a policy, and a header, checks the contents of the rewrite portion of the policy, and outputs the header upon rewriting it.

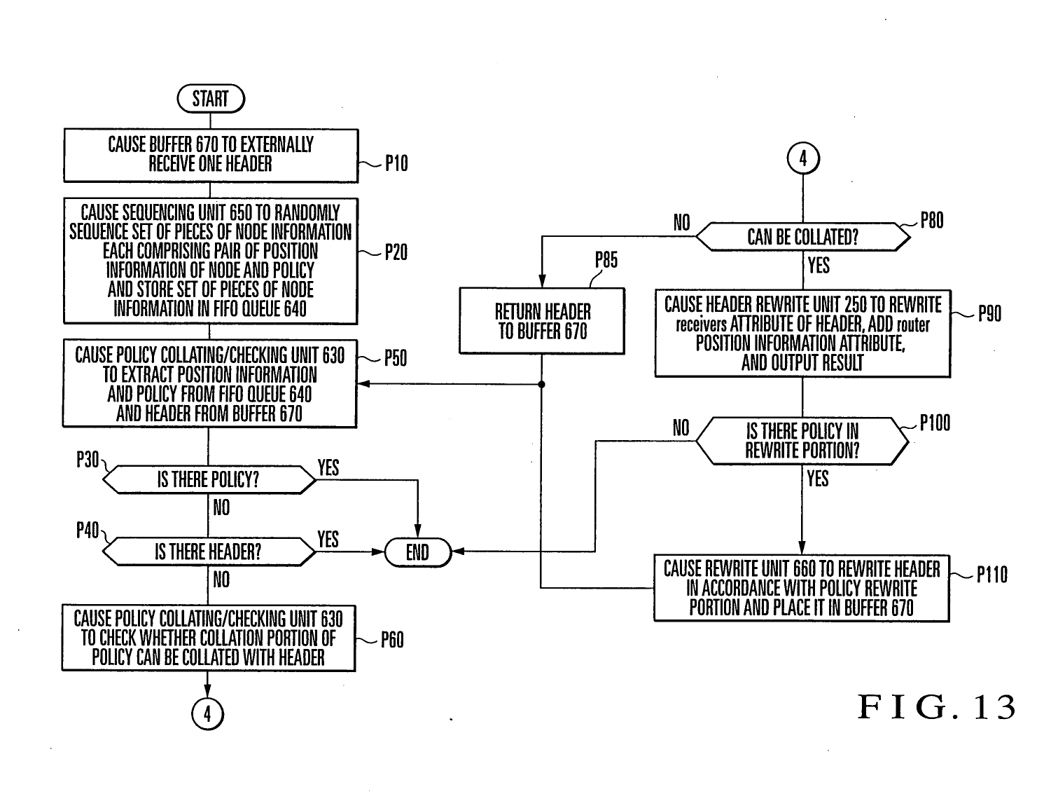

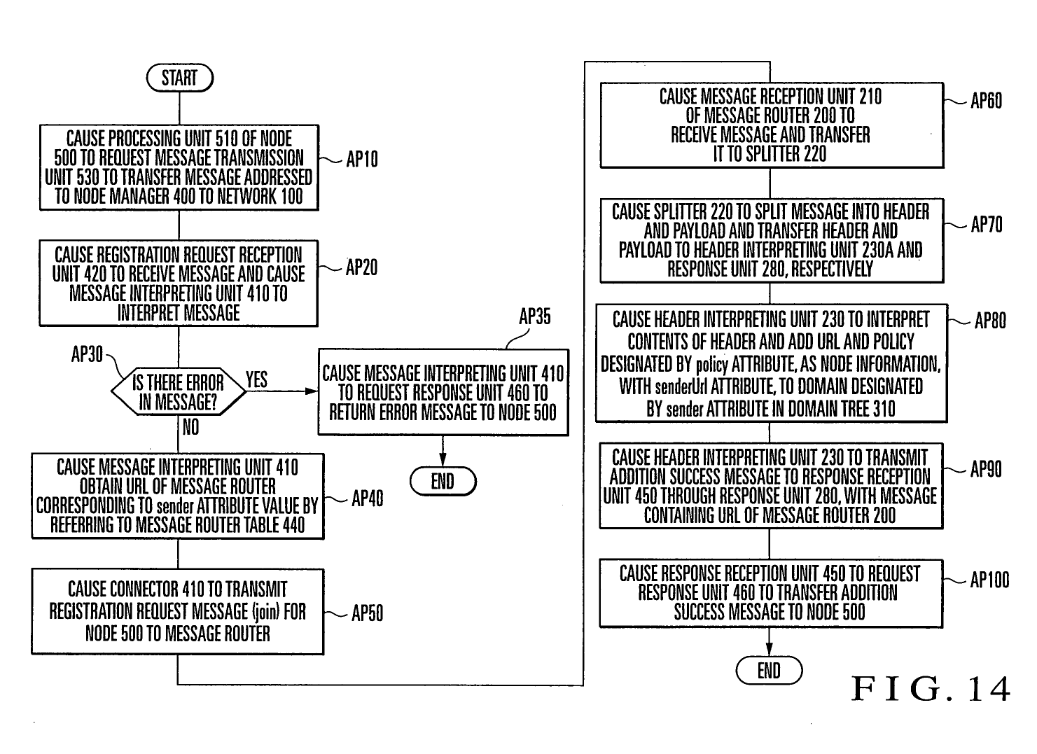

The operation of the policy engine 610 will be described with reference to FIG. 13. The buffer 670 externally receives one header 691 (step P10). The sequencing unit 650 sequences a set 680 of pieces of node information including pairs of the URLs of nodes and policies according to a predetermined rule, and stores the result in the FIFO queue 640 (step P20). In this case, as the predetermined rule, a method of randomly sequencing information may be used, as described above.

The policy collating/checking unit 630 extracts an URL and policy from the FIFO queue 640 and a header from the buffer 670 (step P50). At this time, if no node information exists in the FIFO queue 640, the processing is stopped (step P30). If no header exists in the buffer 670, the processing is stopped (step P40).

The policy collating/checking unit 630 checks whether the collation portion of the policy can be collated with the header (step P60). If they cannot be collated with each other, the header is returned to the buffer 670, and the processing is resumed from step P50 (steps P80 and P85).

Upon receiving the URL and header from the policy collating/checking unit 630, the rewrite unit 250 rewrites an attribute (e.g., receivers attribute) representing the reception node of the header with the domain path of a domain in which node information is stored, adds the value of an attribute (routerUrl attribute) representing the position information of the message router as the position information of the message router, and outputs the pair 690 of the position information and header (step P90). It is then checked whether the policy has a rewrite portion. If no rewrite portion exists, the operation of the policy engine is terminated (step P100).

Upon receiving a combination of collation information, a policy, and a header from the policy collating/checking unit 630, the rewrite unit 660 rewrites the header in accordance with the rewrite portion of the policy, and stores the header in buffer 670 (step P110). After step P110, the flow returns to step P50 to repeat the processing.

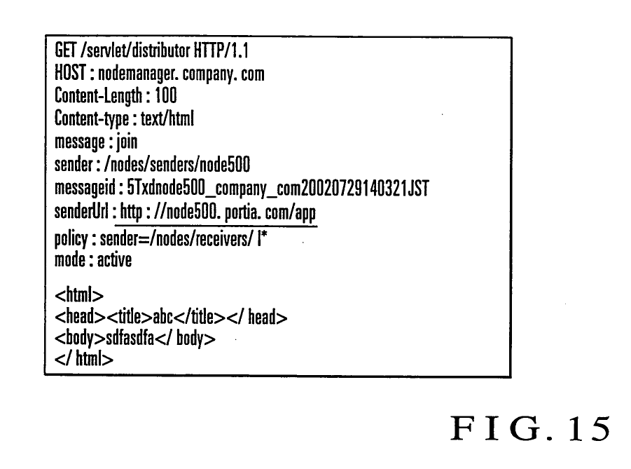

Operation for a node registration request message in the second embodiment of the present invention which uses such a policy engine will be described with reference to FIG. 14. FIG. 15 shows a node registration request message in the second embodiment of the present invention. This message differs from the node registration request message in the first embodiment of the present invention shown in FIG. 10 in that an attribute (e.g., policy attribute) representing a policy exists.

This operation differs from the operation for the node registration request message in the first embodiment of the present invention in that a header interpreting unit 230 adds not only the value of an attribute (e.g., senderUrl attribute) representing the position information of a transmission node but also the value of an attribute representing a policy 320 and registers the pair in the domain tree stored in a database 300 in step AP80. Steps, e.g., steps AP10 and AP20, other than step AP80 in FIG. 14 are the same as steps A10 and A20 in FIG. 9.

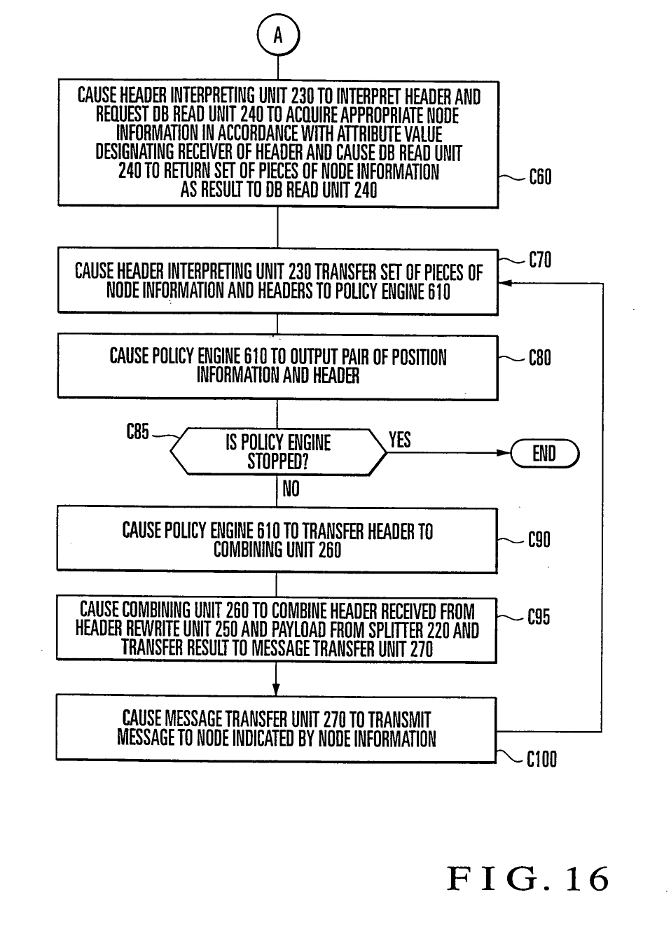

The operation of a message transmission method in the second embodiment of the present invention will be described next with reference to FIG. 16. In the second embodiment, the same operation as that indicated by the flowchart in FIG. 2 is performed. The operation indicated by the flowchart of FIG. 16 will be described as processing following the processing in FIG. 2.

The header interpreting unit 230 interprets a header, and requests a DB read unit 240 to acquire appropriate node information in accordance with the value of an attribute (e.g., receivers attribute) representing the receiver of the header. The DB read unit 240 returns a set of pieces of node information as a result of this operation to the header interpreting unit 230 (step C60). The header interpreting unit 230 transfers the set of pieces of node information and the headers to the policy engine 610 (step C70). The policy engine 610 outputs the pair of the URL and the header (step C80). When the policy engine 610 stops outputting a pair of position information and a header, the processing is terminated (step C85).

The policy engine 610 transfers the header to a combining unit 260 (step C90). The combining unit 260 combines the header received from a header rewrite unit 250 and the payload from the splitter 220, and transfers the result to a message transfer unit 270 (step C95). The message transfer unit 270 transmits the message to the node indicated by the node information (step C100). The processing from step C100 to step C70 is repeated.

The operation of this embodiment will be described next by using a specific example. Assume that the node 501 is registered in advance according to policy “sender=/nodes/senders/|*”, and a node 502 is registered in advance according to policy “sender=/nodes/receivers/|*” as shown in FIG. 15. When the node 500 transmits “send” message, the message shown in FIG. 4 is transmitted. For this message, the value of sender attribute is “/nodes/senders/node500”. A set of node information associated with the node 501 and node information associated with the node 502 is obtained from receivers attribute of the message.

Assume that the sequencing unit 650 of the policy engine 610 randomly places the node information of the node 502 and the node information of the node 501 in the FIFO queue 640 in the order named. First of all, the policy collating/checking unit 630 obtains URL “http://node502.portia.com/app” of the node 502 and policy “sender=/nodes/receivers/|*”. Since the value of sender attribute is “/nodes/receivers/” in a normal expression, the collation portion is not collated with the sender attribute value of the header.

Subsequently, URL “http://node501.portia.com/app” of the node 501 and policy “sender=/nodes/senders/|*” are obtained. This is collated with the sender attribute value of the header. The header rewrite unit 250 rewrites the value of receivers attribute with URL “http://node501.portia.com/app” of the node 501, sets routerUrl attribute as URL “http://distributor.company.com/servlet/distributor”, and transfers the header to the combining unit 260. The combining unit 260 combines the header and payload and transmits the result from the message transfer unit 270 to a node 510.

At the same time, the policy collating unit 630 transfers the policy to the rewrite unit 660. The rewrite portion of the policy is “*” after “|”, which means that the entire header is copied and output without any change. Therefore, the header is placed in the buffer 670 without any change. Although the policy collating unit 630 tries to acquire the next node information from the FIFO queue 640, since the queue has already been empty, the processing is stopped.

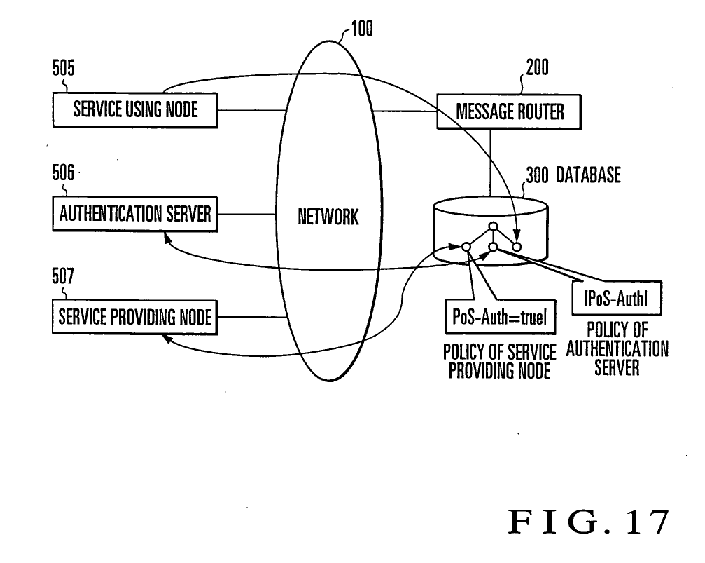

The operation of this embodiment will be described next by using another specific example shown in FIG. 17. Consider a system in which an authentication server 506 exists in addition to a service using node 505 and service providing node 507. Assume that the service providing node 507 has been registered in a domain path /serviceProvider with policy “PoS-Auth=true|”. This policy indicates that when the value of Pos-Auth attribute of the collation portion is “true”, the message is received. Since the right side of “|” is empty, no rewrite portion exists.

Assume that the authentication server 506 has been registered in main path /authorization with policy “!PoS-Auth|”. This policy indicates that when no PoS-Auth attribute exists in the collation portion, the message is accepted. Since the right side of “|” is empty, no rewrite portion exists.

Assume that the service using node 505 sets in advance a user name and password to the value of Authorization attribute in a transmission message according to authentication method Basic. No attribute PoS-Auth exists in a transmission message from the service providing node 507. For this reason, the message coincides with collation portion “!Pos-Auth” of the policy of the authentication server 506, and the message is transferred to the authentication server 506. The authentication server 506 extracts the user name and password contained in Authorization attribute, and perform authentication. If authentication has succeeded, “Pos-Auth:ture” is added to the header. If authentication has failed, “Pos-Auth:false” is added to the header. The resultant message is transferred to the message router 600. If authentication has succeeded, since the value of Pos-Auth attribute is “true”, the transferred message coincides with the policy of the service providing node 507, and is transferred to the service using node 505, thereby providing a service.

In this embodiment, the receivers designated by only a domain path can be limited by using the policy engine 610. This makes it possible to determine a delivery destination by an attribute value in a message header. Changing the attribute value expresses the state of the message and makes it possible to change the delivery destination. That is, a node to which a message should be delivered first is determined in accordance with the state of the message, and delivery destinations are sequentially determined by changing the state of the message, thereby realizing inter-node linkage.

### Third Embodiment

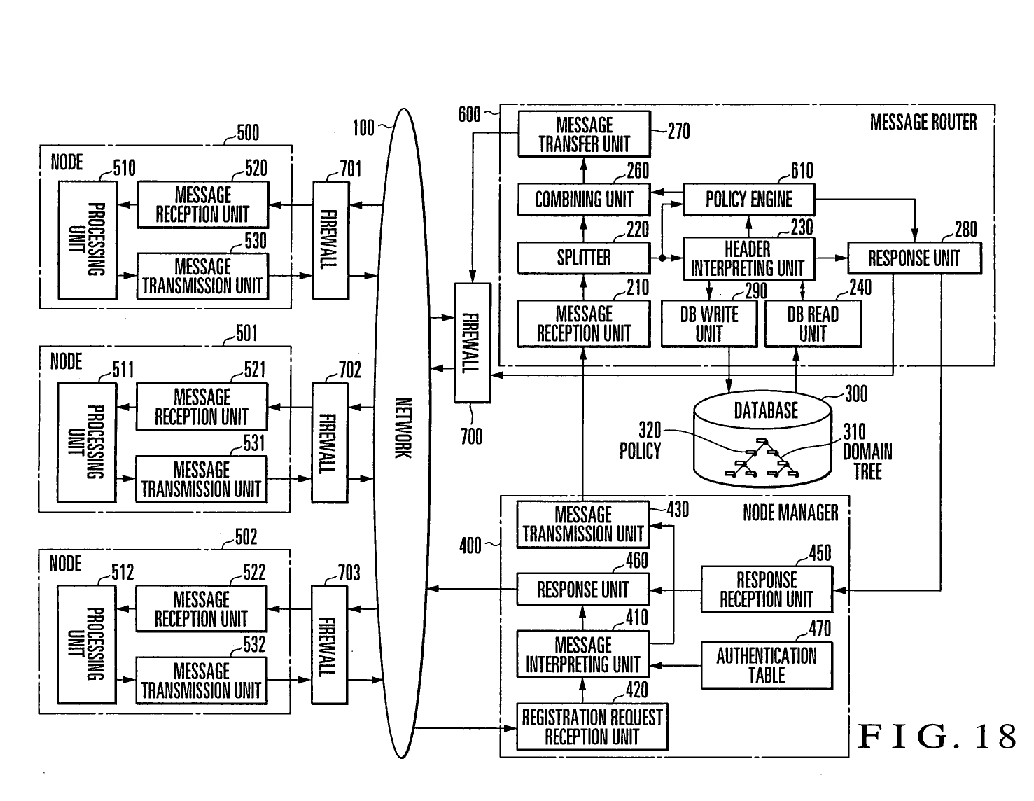

The third embodiment of the present invention will be described next with reference to the accompanying drawings. FIG. 18 is a block diagram showing the third embodiment of the present invention. This embodiment differs from the second embodiment shown in FIG. 11 in that a firewall 700 is placed between a message router 600 and a network 100, and firewalls 701 to 703 are respectively placed between nodes 500 to 502 and the network 100. Other arrangements are the same as those in FIG. 11. This applies to the first embodiment shown in FIG. 1.

A setting can be made in the firewall 700 to specify an IP address from a node manager 400 from which access is permitted. On the other hand, the firewall 701 can be set from the node 500. This also applies to the firewalls 702 and 703. Note that the node manager 400 is provided with an authentication table 470. The authentication table 470 checks whether a user name or password from a message interpreting unit 410 is correct. As an authentication method, for example, the Basic authentication method using Authorization attribute defined in HTTP is available.

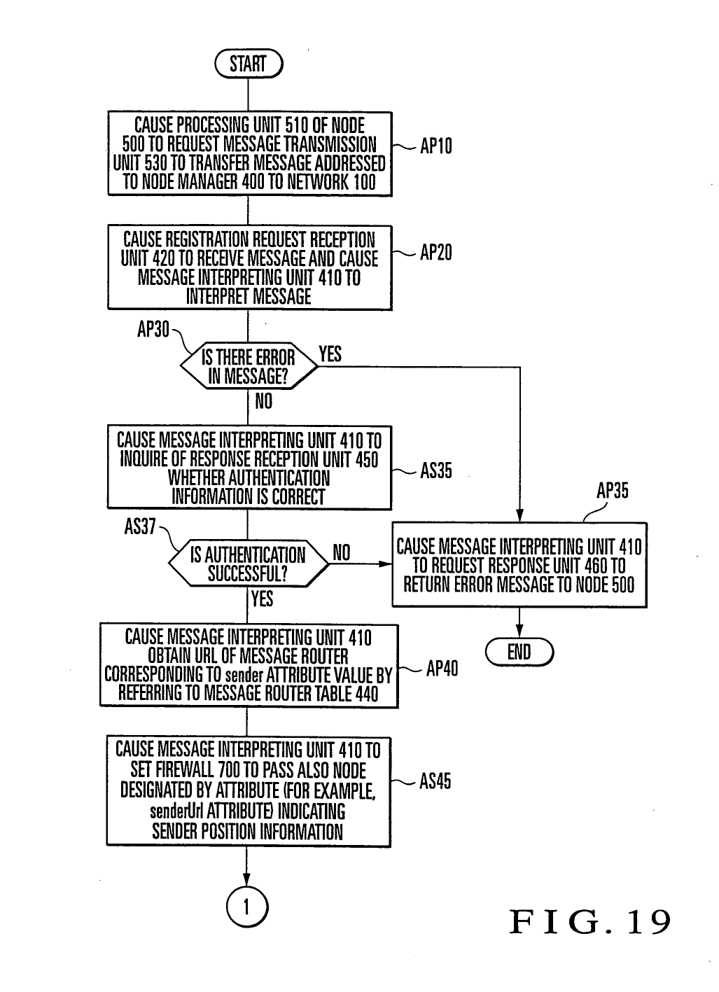

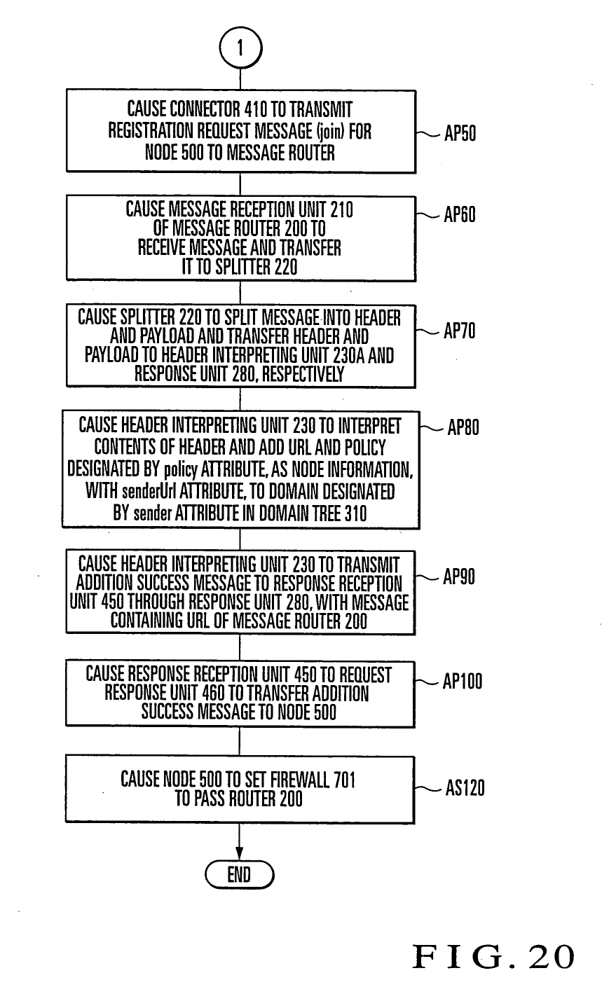

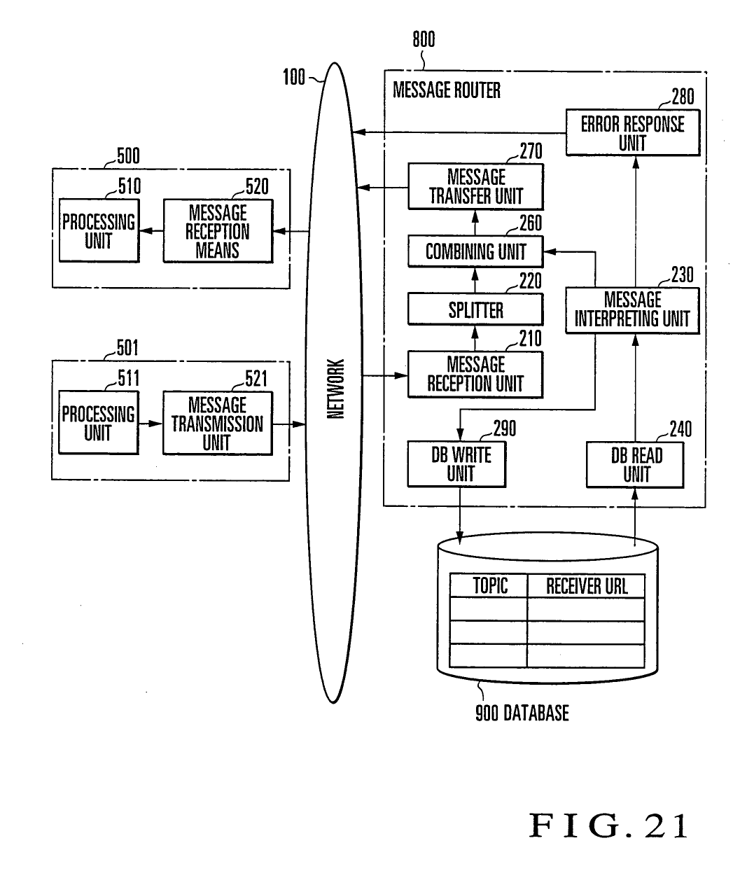

FIGS. 19 and 20 are flowcharts showing the operation of the third embodiment of the present invention. As compared with the flowchart of FIG. 14, these flowcharts additionally include the following points: causing the message interpreting unit 410 to check the validity of authentication information by using the authentication table upon receiving a node registration request message (steps AS35 and AS37); causing the message interpreting unit 410 to make a setting in the firewall 700 so as to pass a node designated by an attribute (e.g., senderUrl attribute) indicating the position information of the transmission node (step AS45); and causing the registration node 500 to check with respect to the firewall 701, at the end of processing, whether processing is correct (step AS120). Other processes are the same as those in FIG. 14 and denoted by the same reference symbols.

The operation of this embodiment will be described by using a specific example. When the node 500 is registered, an authentication method (e.g., Basic), user information, and a password are used as the value of Authorization attribute of HTTP. The node manager 400 performs the same processing as that in the second embodiment, and checks whether the user information and password are listed on the authentication table 470. The message interpreting unit 410 then adds, to the firewall 700, the permission of access from sender attribute value “node500.portia.com of http://node500.portia.com/app” of the message to a message router 600. After registration success, the node 500 sees returned URL “http:.//distributor.compnay.com/servlet/distributor” of the message router, and sets the firewall 701 to permit only access from “distributor.company.com”.

In this case, any malicious server is not authenticated and hence cannot be registered. Even if an unregistered server tries to access the message router, the firewall 700 rejects the access. In addition, the firewall 701 rejects access to the node 500. This makes it possible to defend against attacks using registered servers such as the node 500 as stepping stones, thereby preventing distributed service rejection attacks.

Obviously, the operation flows in the respective embodiments can be sequentially executed by storing the flows as programs in a recording medium in advance and making a CPU (computer) read out them. Although the accompanying drawings show that the database 300 in each embodiment described above is provided independently of the message routers 200 or 600, the database may be provided in the message router 200 or 600. In addition, for the sake of simple illustration, only one message router is shown. In practice, however, a plurality of message routers exist.

The first effect of the above embodiments is that even if an inclusion relation is implied in a topic which determines a message reception target, a message can be transmitted to an appropriate node in accordance with the inclusion relation. This is because node information is managed by a tree data structure called a domain, and an inclusion relation can be expressed by the domain.

The second effect is that linkage can be implemented between a plurality of nodes. For example, after a message is transmitted to a node which provides a given service, a message can be transmitted to a node which provides another service. This is because the state of a message is managed as the attribute of a header according to a policy, and an appropriate delivery destination can be designated in accordance with the state. For example, a policy can be described such that when a node which provides a given service transfers a message upon rewriting the attribute value of the head, the service is regarded as complete, and a message is transferred to a node which provides another service.

The third effect is that a service rejection attack against registered nodes and message routers can be prevented. This is because, since a node is restricted to communicate with only a message router by being registered, communication with other nodes can be rejected by using this and providing a firewall. In addition, since a message router communicate with only registered nodes, a service rejection attack can be prevented by setting a firewall to allow communication with only registered nodes.

The fourth effect is that a distributed service rejection attack against registered nodes and message routers can be prevented. This is because, since a node is restricted to communicate with only a message router by being registered, communication with other nodes can be rejected by using this and providing a firewall. This prevents the use of registered nodes as stepping stones. Furthermore, since message routers communicate with only registered nodes, the user of message routers as stepping stones can be prevented by setting a firewall to allow communication with only registered nodes.

1. A message delivery apparatus which delivers a message to a node connected to a network, characterized by comprising:
a database in which pieces of node information of message delivery destinations are stored as a tree data structure conforming to a predetermined relationship;
retrieval means for retrieving all node information included in sub-trees having, as a root, reception node information of the message which is added to a header portion of the message by accessing the tree data structure of said database on the basis of the reception node information; and
transfer means for transferring the message to delivery destinations corresponding to all the retrieved node information.

2. A message delivery apparatus according to claim 1, characterized by further comprising:
splitting means for splitting the message into a header portion and a payload portion;
interpreting means for interpreting the split header portion and instructing said retrieval means to perform retrieval;
rewrite means for rewriting the header portion in accordance with a message delivery destination retrieved by said retrieval means; and
combining means for combining the rewritten header portion and the payload portion split by said splitting means and sending out the header potion and payload portion to said transfer means.

3. A message delivery apparatus according to claim 1, characterized in that
a pair of the node information and policy information defining a policy for determining the message delivery destination are stored in said database as the tree data structure,
said retrieval means retrieves a pair of the node information and the policy information, and
said transfer means transfers the message in accordance with the retrieved information.

4. A message delivery apparatus according to claim 3, characterized in that said transfer means transfers the message in accordance with a collation result on the retrieved policy information and header portion information of the message.

5. A message delivery apparatus according to claim 4, characterized by further comprising collation means for collating the retrieved policy information with the header portion information of the message and outputting a pair of node information of a delivery destination and header portion information as the collation result.

6. A message delivery method of delivering a message to a node connected to a network, characterized by comprising:
the step of retrieving all node information included in sub-trees having, as a root, reception node information of the message which is added to a header portion of the message by accessing a database in which pieces of node information of message delivery destinations are stored as a tree data structure conforming to a predetermined relationship, on the basis of the reception node information; and
the step of transferring the message to delivery destinations corresponding to all the retrieved node information.

7. A message delivery method according to claim 6, characterized by further comprising:
the step of splitting the message into a header portion and a payload portion;
the step of interpreting the split header portion and instructing to perform retrieval;
the step of rewriting the header portion in accordance with a retrieved message delivery destination; and
the step of combining the rewritten header portion and the split payload portion
wherein the step of transferring comprises the step of transferring the message in accordance with the combined header portion and payload portion.

8. A message delivery method according to claim 6, characterized by further comprising the step of storing a pair of the node information and policy information defining a policy for determining the message delivery destination in the database as the tree data structure,
wherein the step of retrieving comprises the step of retrieving a pair of the node information and the policy information, and
the step of transferring comprises the step of transferring the message in accordance with the retrieved information.

9. A message delivery method according to claim 8, characterized in that the step of transferring comprises the step of transferring the message in accordance with a collation result on the retrieved policy information and header portion information of the message.

10. A message delivery method according to claim 9, characterized by further comprising the step of collating the retrieved policy information with the header portion information of the message and outputting a pair of node information of a delivery destination and header portion information as the collation result.

11. A message delivery system characterized by comprising:
a plurality of nodes which are connected to a network and transmit and receive messages; and
a message delivery apparatus which is connected to the network and delivers a message transmitted from a node to another node,
the message delivery apparatus comprising
a database in which pieces of node information of message delivery destinations are stored as a tree data structure conforming to a predetermined relationship,
retrieval means for retrieving all node information included in sub-trees having, as a root, reception node information of the message which is added to a header portion of the message by accessing the tree data structure of said database on the basis of the reception node information, and
transfer means for transferring the message to delivery destinations corresponding to all the retrieved node information.

12. A message delivery system according to claim 11, characterized by further comprising a node management apparatus which is connected to the network and manages acceptance of a registration request for said node in said database.

13. A message delivery system according to claim 12, characterized in that
said node management apparatus comprises transfer means for transferring the registration request to said message delivery apparatus, and
said message delivery apparatus comprises registration means for registering said node by adding position information of said node, which is contained in the transferred registration request, as node information, to the tree data structure of said database.

14. A message delivery system according to claim 11, characterized by comprising a firewall provided between said message delivery apparatus and said network.

15. A message delivery system according to claim 11, characterized by comprising a firewall provided between said node and said network.

16. A message delivery system according to claim 11, characterized by comprising a firewall provided between said node management apparatus and said network.

17. A program for causing a computer to implement a message delivery method of delivering a message to a node connected to a network, the program causing the computer to implement:
the step of retrieving all node information included in sub-trees having, as a root, reception node information of the message which is added to a header portion of the message by accessing a database in which pieces of node information of message delivery destinations are stored as a tree data structure conforming to a predetermined relationship, on the basis of the reception node information; and
the step of transferring the message to delivery destinations corresponding to all the retrieved node information.

18. A program according to claim 17, which further causes the computer to implement:
the step of splitting the message into a header portion and a payload portion;
the step of interpreting the split header portion and instructing to perform retrieval;
the step of rewriting the header portion in accordance with a retrieved message delivery destination; and
the step of combining the rewritten header portion and the split payload portion
wherein the step of transferring comprises the step of transferring the message in accordance with the combined header portion and payload portion.

19. A program according to claim 18, which further causes the computer to implement:
the step of storing a pair of the node information and policy information defining a policy for determining the message delivery destination in the database as the tree data structure;
the step of retrieving a pair of the node information and the policy information, and
the step of transferring the message in accordance with the retrieved information.

20. A program according to claim 19, wherein the step of transferring comprises the step of transferring the message in accordance with a collation result on the retrieved policy information and header portion information of the message.

21. A program according to claim 20, which further causes the computer to realize the step of collating the retrieved policy information with the header portion information of the message and outputting a pair of node information of a delivery destination and header portion information as the collation result.
